(19) United States
(12) Patent Application Publication
(10) Pub. No.: US 2014/0008905 A1
(43) Pub. Date: Jan. 9, 2014

(54) SUPPORT DEVICE FOR WORK VEHICLES

(71) Applicants: Dietmar Rudy, Kleinbundenbach (DE); Henning Dombek, Saarlouis (DE)

(72) Inventors: Dietmar Rudy, Kleinbundenbach (DE); Henning Dombek, Saarlouis (DE)

(73) Assignee: Schaeffler Technologies AG & Co. KG, Herzogenaurach (DE)

(21) Appl. No.: 13/996,687

(22) PCT Filed: Nov. 24, 2011
(86) PCT No.: PCT/EP2011/070901

§ 371 Date: Aug. 30, 2013

(30) Foreign Application Priority Data
Dec. 21, 2010 (DE) 10 2010 055 416.2

(51) Int. Cl. B60S 9/08; B66C 23/78

(52) U.S. Cl. CPC B60S 9/08; B66C 23/78
USPC 280/766.1

(57) ABSTRACT

A support device for work vehicles, including a support post (8, 46) to be provided on the work vehicle, the lift element (11, 15b) thereof being displaceable along a lift axis for supporting on a support area, wherein the support post (8, 46) has an actuating drive for actuating the lift element (11, 15b), and the actuating drive is designed as a planetary roller screw drive (1, 14).

### BACKGROUND

The present invention relates to a support device for a work vehicle. For example, crane trucks are provided with such a support device that significantly increases the stability of the crane truck; the crane boom can absorb large operating loads that transfer, due to the lever arm, a correspondingly large moment to the crane truck. The support device prevents the tipping over of the crane truck under these operating loads.

From DE 2208333 A, for example, a support device is known in which a support carrier can be moved transverse to the vehicle longitudinal axis and is provided with a support piston on its end facing away from the work vehicle. The support carrier absorbs tipping moments that act on the vehicle. The support piston is provided with a piston rod that is constructed as a lifting element and is provided with a support foot. The support foot can be supported on a support surface, for example, on a road surface. The support piston has a double-acting hydraulic cylinder as an actuating drive for actuating the piston rod. The hydraulic cylinder can be pressurized hydraulically by means of hydraulic lines, in order to actuate the lifting element. The work vehicle is typically equipped with hydraulic pumps that generate the necessary hydraulic pressure.

When hydraulic cylinders are operating, leaks can occur between pistons and cylinders, wherein replacing defective seals can be associated with considerable expense. Furthermore, leaks can occur at the hydraulic lines that are laid from the hydraulic pump to the double-acting cylinder.

### SUMMARY

The object of the invention is to disclose an improved support device.

According to the invention, this objective is met by the support device. Therefore, because the actuating drive has a planetary roller screw drive, wherein planets arranged between the spindle nut of this drive and a threaded spindle are in rolling engagement with the threaded spindle and the spindle nut, wherein a relative rotation between the threaded spindle and the spindle nut is converted into a longitudinal displacement between the threaded spindle and the spindle nut along the lifting axis for a lifting movement of the lifting element, a more powerful mechanical actuating drive is provided. Hydraulic elements are eliminated without replacement. Such planetary roller screw drives can be driven in a simple way by means of small electric motors. Instead of complicated hydraulic lines and hydraulic pumps, only electrical lines are provided that can be connected to the already existing electrical 12 volt or 48 volt on-board power network of the work vehicle.

In addition to the planetary roller screw drive, the actuating drive can have another gear unit that is connected to the planetary roller screw drive. Support devices according to the invention advantageously have an electric motor that drives the planetary roller screw drive as a direct drive. Alternatively, a speed-reducing gear unit can be arranged between the electric motor and the planetary roller screw drive, in order to reduce the rotational speed of the electric motor to the benefit of a higher drive moment on the driven shaft of the intermediate gear unit.

The planetary roller screw drive can be designed so that it is self-locking. If the threaded spindle is arranged along a lifting axis and the full support load is supported by means of the planets, a low pitch of the screw-shaped external profile of the threaded spindle selected as a function of the spindle diameter provides for a self-locking effect. This means that under the external load, there is no relative rotation between the spindle nut and the threaded spindle and thus no lifting movement. The lifting element can selectively comprise the spindle nut or the threaded spindle, so that the spindle nut or the threaded spindle can perform the lifting movement.

For support devices according to the invention, the support piston can be provided on the work vehicle. For example, the support piston can be attached to a typical support carrier of the work vehicle. The support carrier can be moved longitudinally along a support axis arranged transverse to the vehicle longitudinal axis, in order to enlarge the support distance between the vehicle longitudinal axis and the support piston. Instead of a longitudinal displacement, it can also be provided that the support carrier is arranged so that it can pivot about a pivot axis. In this case, the support distance can also be increased.

Planetary roller screw drives are known in different designs and described and shown, for example, in DE 10 2006 060 681 B3, EP 0320621 B1, and DE 3739059 B1. For planetary roller screw drives, relative rotational movements between the threaded spindle and the spindle nut are converted into relative axial movements between the threaded spindle and spindle nut. The planets engage with a first profiling in an external profiling of the threaded spindle. The external profiling is formed by screw-shaped threaded grooves of the threaded spindle wound about the spindle axis, wherein a thread or several threads arranged one behind the other in the axial direction can be provided. The planets further engage with a second profiling in internal profiling on the nut side.

The number of planets arranged distributed around the circumference can vary. The first and second profiles of the planets can have matching designs, so that the planets can be provided as cylinders with a plurality of grooves arranged one behind the other along the planet axis, wherein these grooves are arranged transverse to the planet axis. The grooves can have a ring-shaped form. The nut-side internal profiling can be formed by flanks or grooves that are arranged coaxial to the spindle axis.

When the planetary roller screw drive is actuated, the planets roll both on the spindle nut and also on the threaded spindle. The planets rotate both about their planet axis and also about the spindle axis. The rotational speed of the planets about the spindle axis is less than the rotational speed of the driven threaded spindle, for example. Only after one complete revolution of all the planets is an advance between the threaded spindle and the spindle nut reached that corresponds to the pitch of the threaded spindle. The pitch indicates the axial progress of one complete winding of a thread of the threaded spindle. The total pitch of the planetary roller screw drive and the pitch of the threaded spindle are different.

Relative rotation between the spindle nut and the threaded spindle produces an axial advance that is converted into a lifting of the lifting element. Advantageously, the axial advance is used directly for the lifting of the lifting element, wherein the threaded spindle can absorb the full lifting load. The lifting element can have the threaded spindle or the spindle nut. If, for example, the spindle nut is driven, the threaded spindle can perform the axial advance; in this case, the lifting element comprises the threaded spindle. If the threaded spindle is driven, the spindle nut can perform the axial advance; in this case, the lifting element comprises the spindle nut. In all cases, the planets can transfer the support load between the threaded spindle and the spindle nut.

The support element can have a housing in which the threaded spindle and alternatively the spindle nut is supported so that it can rotate.

Advantageously, planetary roller screw drives can be used whose threaded spindles are provided with very small pitches, so that these planetary roller screw drives can be self-locking. This means that, in this case, no additional precautionary measures are required that prevent an undesired retraction of the lifting element under the support load. The planets can transfer the support load between the threaded spindle and the spindle nut in that the flanks of the profiles of the planets are supported, on one side, on the flanks of the external profiling of the threaded spindle and, on the other side, on the flanks of the nut-side internal profiling.

The small pitches also allow a lifting of larger loads. The gear-transmission ratio between the spindle nut and threaded spindle can be selected so that, on one hand, a lifting of larger loads for relatively small rotational moments of the driven threaded spindle or the driven spindle nut is enabled and, on the other hand, a self-locking effect can be ensured.

Support devices according to the invention therefore can be provided with electric motors that generate the necessary actuating movements of the lifting element with low power. In particular, the 12-V or 48-V on-board power network of the work vehicle can provide sufficient electrical power. In particular, a multi-pole direct-current motor is suitable as the electric motor.

Direct drives can be realized, wherein a rotor of the electric motor is arranged coaxial to the threaded spindle and drives either the threaded spindle or the spindle nut.

Alternatively, the electric motor can be arranged on the post offset relative to the spindle axis and, if necessary, connected to the planetary roller screw drive by means of a gear unit. For example, a spur gear drive, a worm drive, or a traction mechanism drive is conceivable, with this drive being connected to the threaded spindle or to the spindle nut on the drive side. Traction mechanism drives have, as the traction mechanism, a chain or a belt. Favorably, the drive is constructed as a speed-reducing gear unit, so that a high rotational speed of the rotor of the electric motor is stepped down to the benefit of an improved rotational moment on the drive-side driven shaft.

The lifting element has at least one lifting part that is connected, on one side, to the threaded spindle or to the spindle nut for a common lifting movement. This lifting part can have a tubular construction and thus can be lightweight. On the other hand, this lifting part can be provided with a support foot for supporting on the support surface. In the simplest case, the lifting part can be formed by the threaded spindle.

Advantageously, the support piston has a receptacle for the lifting element and the lifting element can be inserted into this receptacle. The structural height of the support piston according to the invention can then correspond to approximately the height of the receptacle. It is also possible, however, to provide the receptacle with a lead-through for the lifting element along the lifting axis; then the receptacle can have a short construction along the lifting axis.

If the threaded spindle is driven, that is, it is to be rotated, it can be supported in the radial and axial directions in the receptacle of the support piston, for example, by means of one or more anti-friction bearings that can be constructed as deep groove ball bearings or as needle bearings or roller bearings.

Other forms of planetary roller screw drives can also be used in a support device according to the invention. For example, planets can be used that have only one uniform groove profile meshing with both the spindle nut and also with the threaded spindle. In each case, the planets are in rolling engagement both with the threaded spindle and also with the spindle nut, wherein, when the planetary roller screw drive is actuated, the planets rotate about their planet axis and roll both on the inner circumference of the spindle nut and also on the outer circumference of the threaded spindle.

For support devices according to the invention, the threaded spindle can be arranged coaxial to the lifting axis of the lifting element. These support devices according to the invention make possible compact structural forms that allow simple storing on the work vehicle.

### BRIEF DESCRIPTION OF THE DRAWINGS

The invention is explained in more detail below using four embodiments shown in a total of eleven figures. Shown are:

FIGS. 1 and 2 a support device according to the invention in longitudinal section with retracted and extended support piston,

FIGS. 3 and 4 another support device according to the invention in longitudinal section with retracted and extended support piston,

FIGS. 5 and 6 a work vehicle with a support device according to the invention,

FIGS. 7 and 8 another support device according to the invention in longitudinal section with retracted and extended support piston,

FIGS. 9 and 10 another support device according to the invention in longitudinal section with retracted and extended support piston, and

FIG. 11 a known planetary roller screw drive.

### DETAILED DESCRIPTION OF THE PREFERRED EMBODIMENTS

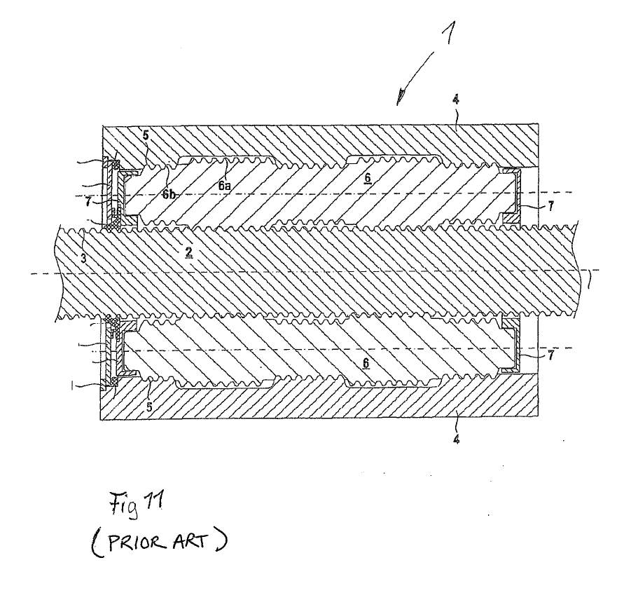

FIG. 11 shows, in a longitudinal section, a known planetary roller screw drive 1 according to DE 10 2006 060 681 B3 for converting a rotational movement into an axial movement or vice versa. The planetary roller screw drive 1 comprises a threaded spindle 2 that has, on its lateral surface, an external profiling 3 in the form of grooves. The threaded spindle 2 thus forms a threaded spindle and can form the shaft of an electric motor. The threaded spindle 2 is surrounded by a spindle nut 4, wherein the spindle nut 4 can rotate relative to the threaded spindle 2. An internal profiling 5 in the form of grooves is provided on the inside of the spindle nut 4.

Between the hollow cylindrical spindle nut 4 and the threaded spindle 2 there is a specified number of planets 6. The planets 6 are arranged offset in equidistant angular distances in the peripheral direction of the threaded spindle 2, wherein the longitudinal axes of the planets 6 run parallel to the longitudinal axis L of the threaded spindle 2. The longitudinal-side ends of the planets 6 are each supported in a spacer washer 7 so that it can rotate. The planets 6 each have a first profiling 6a and a second profiling 6b. The first profiling 6a produces an axial non-positive fit of the planets 6 with the threaded spindle 2, in that this profiling 6a is guided into the external profiling 3 of the threaded spindle 2. These first profiles 6a form advance grooves. The second profiling 6b produces an axial non-positive fit of the planets 6 with the spindle nut 4, in that this profile 6b is guided into the inner profiling 5 of the spindle nut 4. These second profiles 6b form guide grooves.

The spacer washers 7 holding the longitudinal-side ends are used as spacers for the planets 6. The identical spacer washers 7 have a circular disk-shaped form. In the center of each spacer washer 7 there is a drilled hole through which the threaded spindle 2 is guided. On the side facing the planets 6 of each spacer washer 7 there are receptacles 7a for the ends of the roller body 6. The planets 6 are supported in these receptacles 7a so that they can rotate. The spacer washers 7 each lie at a distance to the spindle nut 4 and to the threaded spindle 2.

The profiles 6a of the individual planets 6 are offset relative to each other. Here, the profiling 6a of each planet 6 has a defined axial offset relative to the preceding planet 6. The offset profiling structures of the planets 6 form a thread for the external profiling 3 of the threaded spindle 2. For a relative movement of the threaded spindle 2 relative to the spindle nut 4, the planets 6 roll with the profiles 6a on the external profiling 3, wherein, at the same time, the second profiles 6b are guided into the internal profiling 5 of the spindle nut 4. For a stationary spindle nut 4 and rotating threaded spindle 2, the planets 6 supported in the spacer washers 7 rotate on the lateral surface of the threaded spindle 2, wherein this movement is slower than the rotational movement of the threaded spindle 2. The rotational movements are realized such that only after one complete revolution of the planets 6 about the spindle nut 4, the threaded spindle 2 has shifted in the axial direction by the magnitude of the pitch of the external profiling 3 relative to the spindle nut 4.

As can be seen from FIG. 11, means for sealing this spacer washer 7 relative to the spindle nut 4 and the threaded spindle 2 are provided on a spacer washer 7. In general, such means for sealing can also be provided on both spacer washers 7, wherein these preferably have an identical construction.

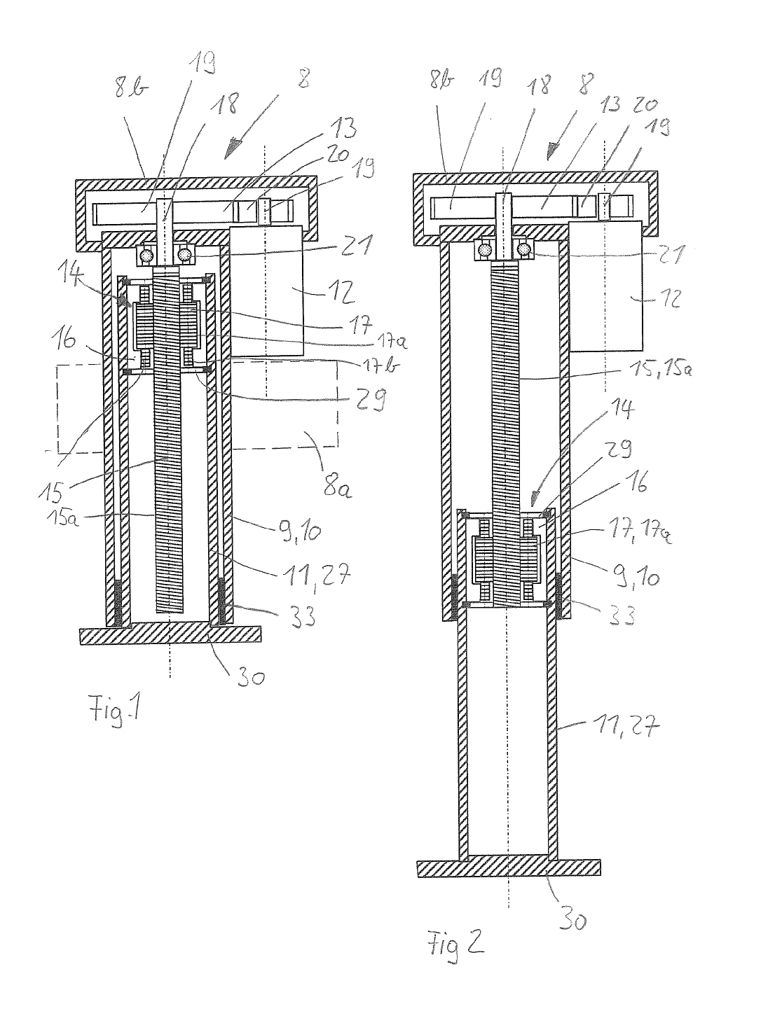

FIG. 1 shows a support device according to the invention in longitudinal section. A support piston 8 is held on a support carrier 8a that is only indicated here. The support carrier 8a is supported on a work vehicle that is not shown here. The support piston 8 is provided with a hollow receptacle 9 that is formed from a tube 10. A lifting element 11 is arranged in the receptacle 9. An electric motor 12 that is constructed as a multi-pole direct-current motor and is connected to a planetary roller screw drive 14 by means of a spur gear drive 13 is also arranged on the support piston 8a. The spur gear drive 13 is constructed as a speed-reducing gear with which high rotational speeds of the electric motor 12 is reduced to a relatively low rotational speed of a threaded spindle 15 of the planetary roller screw drive 14. The support piston 8 has a housing 8b in which the spur gear drive 13 is housed.

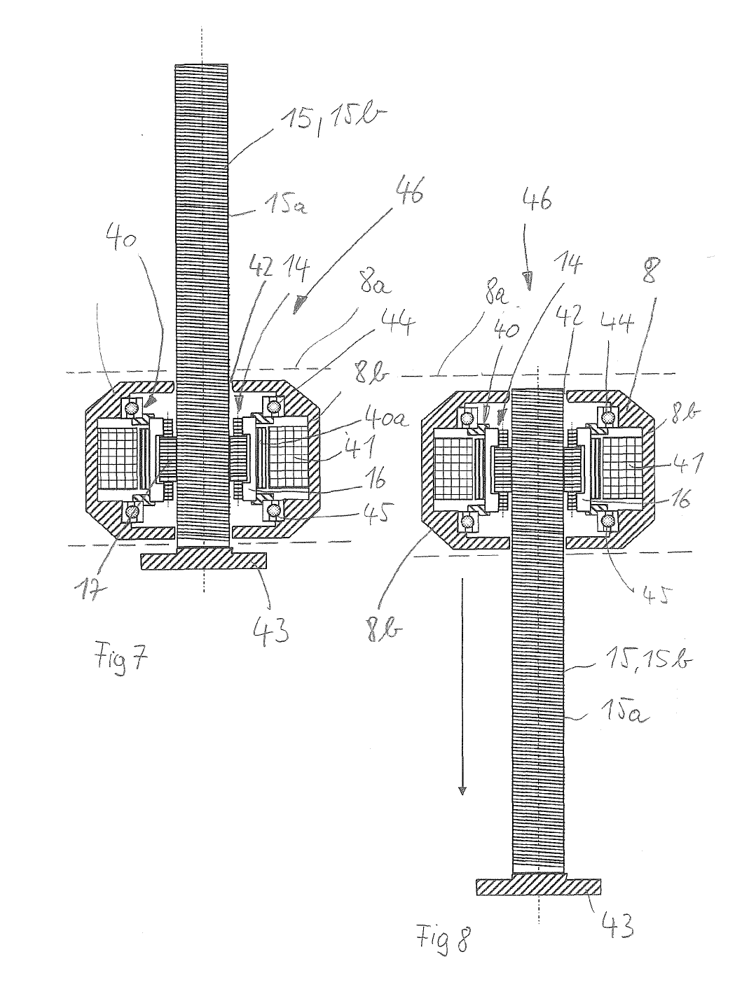

This planetary roller screw drive 14 corresponds in its structural design to the planetary roller screw drive 1 described previously for FIG. 7. Between the threaded spindle 15 and a spindle nut 16 there are planets 17 that are arranged distributed around the circumference and are in rolling engagement in the described way both with the threaded spindle 15 and also with the spindle nut 16. While the planets 6 of the planetary roller screw drive 1 each have two sections with a profiling 6a, the planets 17 of the planetary roller screw drive 14 have only one section with such a profiling 17a for engagement with an external profiling 15a of the threaded spindle 15, wherein this external profiling 15a is constructed as a screw-shaped thread groove.

The threaded spindle 15 is provided on its end facing the spur gear drive 13 with a drive shaft 18 in axial extension on which a spur gear 19 of the spur gear drive 13 is locked in rotation. A spur gear 20 that meshes with the spur gear 19 is locked in rotation on a motor shaft 19 of the electric motor 12. The drive shaft 18 can be provided with spline teeth and the spur gear 19 can be provided with internal contours adapted to the spline teeth, so that a preassembled unit—consisting of the lifting element 11, planetary roller screw drive 15, as well as tube 10—can be inserted into the spur gear 19 already preassembled on the stator side.

The threaded spindle 15 is supported in the radial and axial directions relative to the housing 8b by means of an upper support bearing 21 constructed as a ball bearing. The threaded spindle 15 is supported by means of another axial bearing not shown here relative to the housing 8b. Forces transmitted by the lifting element 11 are guided via the upper support bearing 21 and the not-shown axial bearing into the housing 8b.

The lifting element 11 has a tubular lifting part 27 that holds the spindle nut 16 of the planetary roller screw drive 14 that is held by means of retaining rings 29 in the axial direction on the lifting part 27. The lifting part 27 is provided on its end facing away from the spur gear drive 13 with a support foot 30 that is provided for contact on a support surface. The lifting part 27 is supported on the tube 10 in the radial direction by means of a sliding bearing 33.

The threaded spindle 15 and the lifting part 27 are arranged coaxial relative to each other, wherein the threaded spindle 15 enters into the inner lifting part 27 in the retracted state of the lifting element 11.

FIG. 2 shows the support piston 8 in the extended state, wherein the lifting part 27 is extended out of the receptacle 9 of the housing 8b.

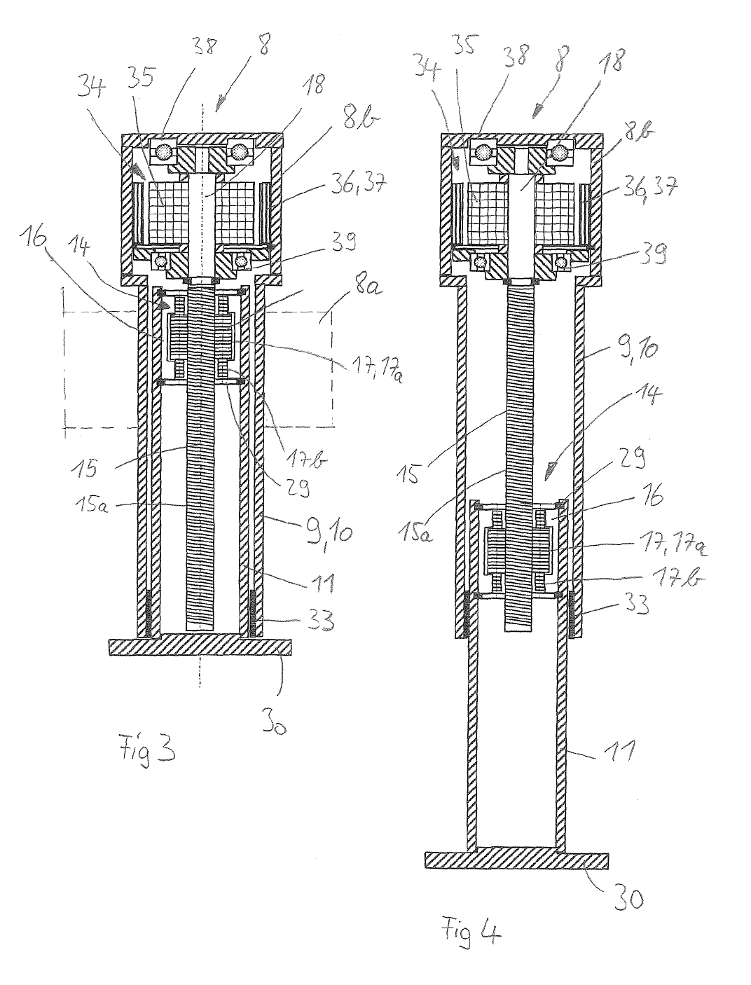

FIGS. 3 and 4 show an alternative support device according to the invention that differs from the support device shown in FIG. 1 essentially in that a direct drive is provided in order to drive the drive shaft 18. FIG. 3 shows the support device with retracted lifting element 11 and FIG. 4 shows the support device with an extended lifting element 11.

An electric motor 34 is arranged coaxial to the threaded spindle 15. A rotor 35 of the electric motor 34 is provided with coils. A ring 36 held in the housing 8b of the support piston 8 forms a stator 37. The drive shaft 18 is connected to the rotor 35 for transmitting rotational movements. This variant allows a gear unit between the drive shaft 18 and the electric motor 34 to be eliminated and therefore has an extremely space-saving design.

The drive shaft 18 is supported by means of an upper support bearing 38 and also by means of a lower support bearing 39 relative to the housing 8b. The upper support bearing 38 is constructed as an axial anti-friction bearing and the lower support bearing 39 is constructed as a radial anti-friction bearing.

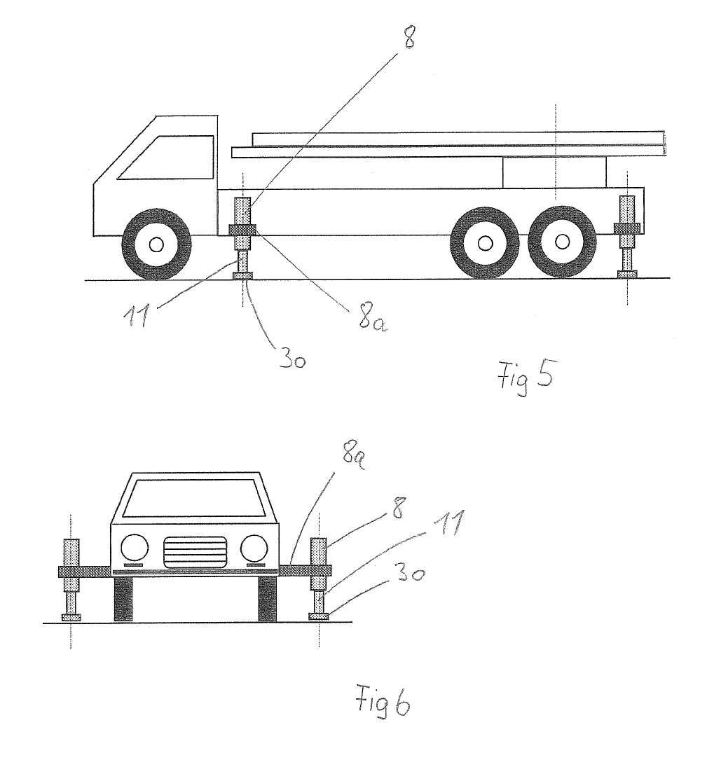

FIGS. 5 and 6 show a work vehicle with the support device according to the invention from FIGS. 3 and 4. A total of four support pistons 8 are held on four support carriers 8a. On the two longitudinal sides, two support pistons 8 and two support carriers 8a are provided.

Below, the mode of action of the support devices according to the invention described above is explained in more detail using FIGS. 3, 4, 5, and 6. The mode of action of the support device according to the invention from FIGS. 3 and 4 does not differ from that from FIGS. 1 and 2 only by the spur gear drive connected between the electric motor and the planetary roller screw drive.

When the electric motor 34 is actuated, the threaded spindle 15 of the planetary roller screw drive 14 is set in rotation. The planets 17 roll with their first profiling 17a on the screw-shaped external profiling 15a of the threaded spindle 15 wound around the spindle axis. The planets 17 also roll with their second profiling 17b on the internal profiling 16a constructed on the inner circumference of the spindle nut 16. Due to the described screw movement, the lifting element 11 is moved with the spindle nut 16 along the lifting axis from the receptacle 9 of the tube 10, wherein the tubular lifting part 27 does not rotate.

The lifting element 11 is extended until the support foot 30 contacts the support surface—e.g., the roadway. The four support pistons 8 allow a secure support of the work vehicle. The lifting elements 11 can be extended until the wheels of the work vehicle lift from the roadway.

The pitch of the screw-shaped external profiling of the threaded spindle is selected as a function of the spindle diameter, so that the support piston 8 is self-locking.

FIGS. 7 and 8 show another support device according to the invention that is provided with a direct drive just like the support device from FIGS. 3 and 4.

A support piston 46 provided in this embodiment has an electric motor 40 that is held in the housing 8b and drives the spindle nut 16 of the planetary roller screw drive 14, while the threaded spindle 15 is locked in rotation.

The threaded spindle 15 with the connected support foot 43 here simultaneously forms a lifting element 15b that can also be designated in the present document as a lifting part. The threaded spindle 15 can be supported in the radial direction on the housing 8b by means of a radial bearing not shown here.

The spindle nut 16 is locked in rotation with a rotor 40a, while a stator 41 is locked in rotation in the housing 8b. The spindle nut 16 is supported by means of two angular contact ball bearings 44, 45 upright in an X-arrangement so that it can rotate in the housing 8b.

The housing 8b is provided with a lead-through 42 for the threaded spindle 15. On its lower end shown in FIGS. 7 and 8, the threaded spindle 15 is provided with a support foot 43.

The support carrier 8a is merely indicated.

When the electric motor 40 is actuated, the spindle nut 16 of the planetary roller screw drive 14 rotates. The planets 17 roll, on one side, on the spindle nut 16 and, on the other side, on the threaded spindle 15, wherein the threaded spindle 15 undergoes an axial advance. FIG. 8 shows the extended position of the self-locking support piston 46.

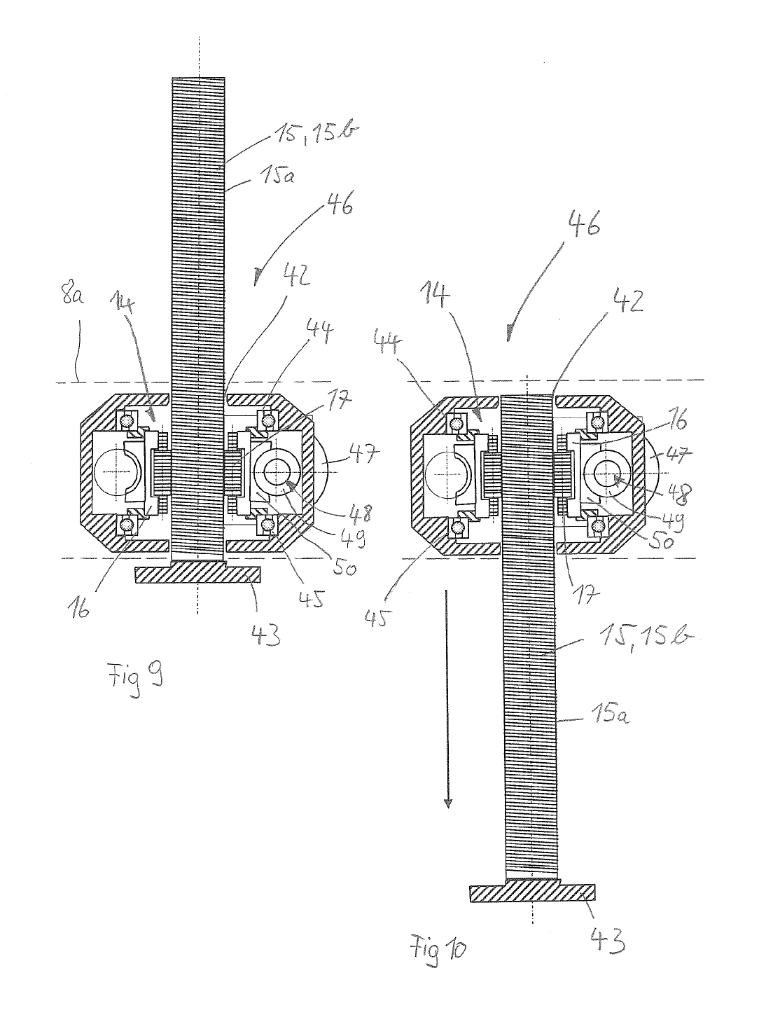

The support device according to the invention shown in FIGS. 9 and 10 differs from the support device shown in FIGS. 7 and 8 essentially in that an electric motor 47 is provided that drives the spindle nut 16 of the planetary roller screw drive 14 by means of a worm drive 48. For this purpose, a worm 49 locked in rotation with the motor shaft of the electric motor 47 meshes with a worm gear 50 locked in rotation with the spindle nut 16. Incidentally, the structure and mode of action of this support device according to the invention match that from FIGS. 7 and 8.

### LIST OF REFERENCE NUMBERS

1 Planetary roller screw drive
2 Threaded spindle
3 External profiling
4 Spindle nut
5 Internal profiling
6 Planet
6a First profiling
6b Second profiling
7 Spacer
8 Support piston
8a Support carrier
8b Housing
9 Receptacle
10 Tube
11 Lifting element
12 Electric motor
13 Spur gear drive
14 Planetary roller screw drive
15 Threaded spindle
15a External profiling
15b Lifting element
16 Spindle nut
16a Internal profiling
17 Planet
17a First profiling
17b Second profiling
18 Driveshaft
19 Motor shaft
20 Spur gear
21 Upper support bearing
22
23
24
25
26
27 Lifting part
28
29 Retaining ring
30 Support foot
31
32
33 Sliding bearing
34 Electric motor
35 Rotor
36 Ring
37 Stator
38 Upper support bearing
39 Lower support bearing
40 Electric motor
40a Rotor
41 Stator
42 Lead-through
43 Support foot
44 Angular contact ball bearing
45 Angular contact ball bearing
46 Support piston
47 Electric motor
48 Worm drive
49 Worm
50 Worm gear

1. A support device for work vehicles, comprising a support piston to be provided on the work vehicle, support piston having a lifting element that is movable along a lifting axis for supporting on a support surface, the support piston further including an actuating drive for actuating the lifting element, the actuating drive has a planetary roller screw drive including planets arranged between a spindle nut of said drive and a threaded spindle, the planets are in rolling engagement with the threaded spindle and the spindle nut, and a relative rotation between the threaded spindle and the spindle nut is converted into a longitudinal displacement between the threaded spindle and the spindle nut along the lifting axis for a lifting movement of the lifting element.

2. The support device according to claim 1, wherein the threaded spindle is supported rotatable relative to a housing of the support piston, also the spindle nut allocated to the lifting element is arranged movable in an axial direction relative to the housing.

3. The support device according to claim 1, wherein the housing has a receptacle for the lifting element, and the lifting element enters into the receptacle in a retracted position.

4. The support device according to claim 1, wherein an electric motor is provided having a rotor or a motor shaft that drives the threaded spindle or the spindle nut.

5. The support device according to claim 4, wherein the rotor of the electric motor is arranged coaxial to the threaded spindle.

6. The support device according to claim 5, wherein the motor shaft of the electric motor drives the threaded spindle or the spindle nut by means of via a drive unit.

7. The support device according to claim 1, wherein the threaded spindle is arranged coaxial to the lifting axis of the lifting element.

8. The support device according to claim 1, wherein the planets have a first profiling for engagement in external profiling of the threaded spindle and a second profiling for engagement in internal profiling of the spindle nut.

9. The support device according to claim 1, wherein a housing of the support piston is provided with a lead-through for the threaded spindle.

10. The support device according to claim 1, further comprising a support carrier that is extendable transverse to a vehicle longitudinal axis is supported on the work vehicle for absorbing tilting moments, and the support piston is arranged on the support carrier.
